(19) United States
(12) Patent Application Publication
(10) Pub. No.: US 2010/0227499 A1
(43) Pub. Date: Sep. 9, 2010

(54) HANGING FIXTURE MAINTENANCE DEVICE

(76) Inventors: Anthony Ramos, Suisun City, CA (US); Ron Bianco, Vallejo, CA (US)

Correspondence Address: Bay Area Technolgy Law Group PC, 500 Sansome Street, Suite 404, San Francisco, CA, 94111, US

(21) Appl. No.: 12/400,693

(22) Filed: Mar. 9, 2009

(51) Int. Cl. H01R 13/73; H02G 7/00; F21S 8/04

(52) U.S. Cl. 439/537; 174/40 R; 362/405; 362/147

(57) ABSTRACT

A device for facilitating the maintenance of an electrified fixture hung from the ceiling. The fixture is in the form of a multi-part mounting bracket, a first part of the mounting bracket being affixed to the fixture and the second part of the mounting bracket being affixed to the ceiling A cable is affixed to the first part of the mounting bracket and to a winch for selectively paying out withdrawing the cable for selectively lowering the first part of the mounting bracket and the fixture and for selectively separating the first and second parts of the mounting bracket.

### TECHNICAL FIELD

The current invention is intended to be installed both during new construction and as an aftermarket kit to enable a user to selectively lower an electrified fixture from a ceiling in order to facilitate its maintenance without the need for a ladder.

### BACKGROUND OF THE INVENTION

A vast majority of residences as well as a significant number of commercial and industrial facilities employ electrified fixtures hung from a ceiling or the like including domes, beams, etc. For example, many homes have motorized ceiling fans as well as chandeliers. Such fixtures are oftentimes hung from ceilings well above the reach of an average user. Thus, in order to service such fixtures, one must erect a ladder or hire through rental services a man lift proximate the fixture to enable fixture cleaning and bulb replacement, and/or fixture replacement.

Whenever a fixture, such as the blades, of a fan is to be cleaned or bulbs replaced in a chandelier, a user generally is called upon to climb a significantly high ladder or hire through rental services a man lift with a duster and replacement bulbs in hand. It is not uncommon for one to lose one's balance in doing so. This can result in significant bodily injury as well as damage to the fixture as a natural tendency of one losing one's balance is to grab a hold of anything that might be thought of to reestablish one's balance and prevent a tipping of the ladder. Unfortunately, ceiling fans, chandeliers and other overhead fixtures make for poor supports and one's weight can easily rip such a fixture from the ceiling further adding to what amounts to a costly and dangerous situation.

It is thus an object of the present invention to provide a device which could either be built into a structure when erected or employed as a kit for retrofitting an existing installation enabling one to easily and conveniently lower a fixture to a level enabling the user to maintain it without the need for a ladder or similar expedient. These and further objects will be mote readily apparent when considering the following disclosure and appended drawings.

### SUMMARY OF THE INVENTION

A device for facilitating the maintenance of an electrified fixture hung from a ceiling and the like The fixture is in the form of a multi-part mounting bracket, a first part of the mounting bracket being affixed to the fixture and the second part of the mounting bracket being affixed to the ceiling or electrician's roughed-in mounting bracket. A cable is affixed to the first part of the mounting bracket and to a winch for selectively paying out withdrawing the cable for selectively lowering the first part of the mounting bracket and the fixture and for selectively separating the first and second parts of the mounting bracket. The first and second parts of the mounting bracket comprise electrical connectors aligned with one another such that when the first and second parts of the mounting bracket are in a first orientation, electric current is capable of passing therethrough for selectively powering the electrified figure and when the first and second parts of the mounting bracket are in a second orientation, electric current does not pass therethrough.

### BRIEF DESCRIPTION OF THE FIGURES

FIG. 1 is a side schematic view of the present invention configured as part of an original installation.

FIG. 2 is a side schematic view of the present invention used to modify a pre-existing installation.

FIGS. 3a and 3b are side plan views of typical electrified fixtures in the form of a ceiling fan and chandelier typical of those fixtures which could most benefit by employing the present invention.

### DETAILED DESCRIPTION OF THE INVENTION

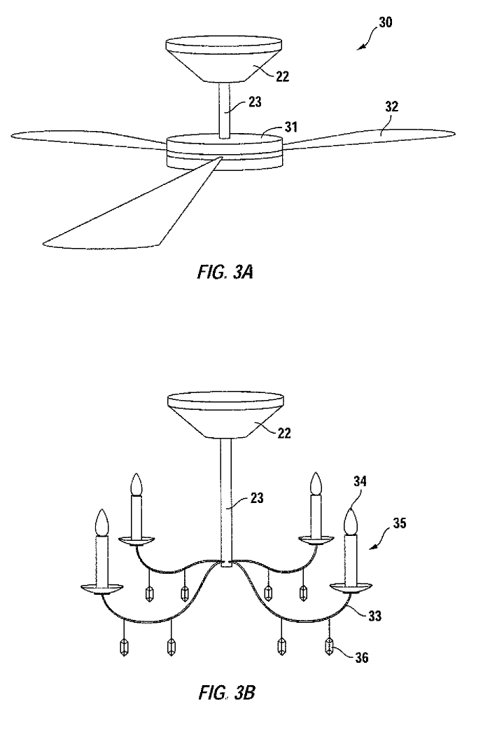

As noted previously, the present invention is directed to a device for facilitating the maintenance of an electrified fixture hung from a ceiling. The fixture, such as fan 30 (FIG. 3a) or chandelier 35 (FIG. 3b), is joined to multi-part mounting bracket 5 including first part 26 affixed at fixture unit 22 and second part 16 affixed to the ceiling through use of ceiling bracket 15 affixed to stud or rafter or engineered structural member 14. Although depicted in cross section, mounting bracket 5 is generally circular having electric contact rings 17 and 19, respectively, such that when first and second parts 26 and 16 are in physical contact, an electrical connection is established through said contact rings 17 and 19. Conversely, as will be more fully discussed below, when first and second parts 26 and 16 of mounting bracket 5 are separated, contact rings 17 and 19 are separated thus breaking electrical contact with fixtures 30 and 35. Thus, when these fixtures are lowered to facilitate maintenance, power is broken to prevent injury to a user.

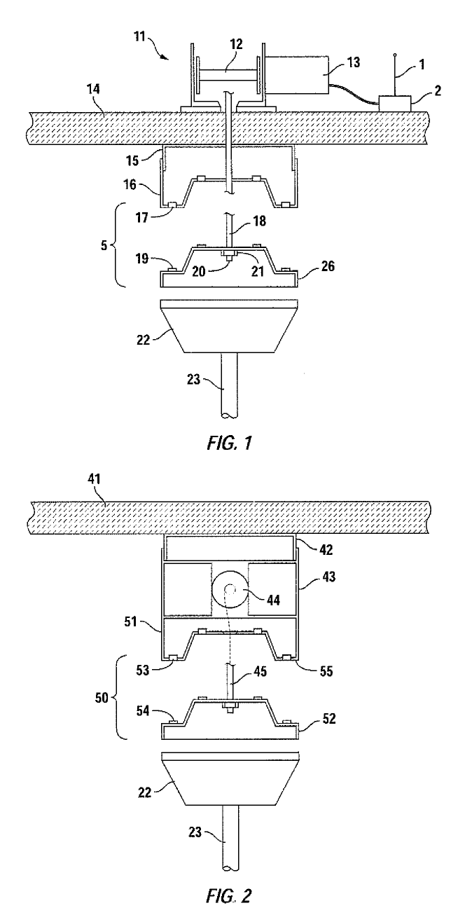

In further reference to FIG. 1, winch 11, during construction, is affixed atop stud or rafter 14. The winch is composed of two-way motor 13 and spool 12 upon which cable 18 is withdrawn or payed out. Cable 18 passes through stud or rafter 14 as well as through second part 16 of multi-part mounting bracket 5 terminating at first part 26 by passing cable 18 therethrough and terminating at threaded end 20 through the use of bolt 21. As such, when two-way motor 13 is caused to turn spool 12 in a direction to withdraw and thus wind cable 18 thereon, mounting bracket first part 26 is caused to abut against mounting bracket second part 16 establishing electrical contact and establishing the in-use height of the appropriate electrified fixture. When the appropriate switch (not shown) is activated causing two-way motor 13 to turn spool 12 paying out cable 18, first part 26 of mounting bracket 5 is lowered away from second part 16 of mounting bracket 5 thus interrupting electrical connectivity to the appropriate electrified fixture while lowering the fixture to enable a user to conveniently service the same.

FIG. 2 represents an installation similar to FIG. 1, but, in this instance, the device is in the form of a kit used to retrofit an existing installation. In this instance, a kit is provided whereby the fixture and its appropriate fixture unit 22 are removed from their ceiling bracket 42, the latter being affixed to stud or rafter 41. Specifically, housing 43 is appended to ceiling bracket 42, housing 43 containing a winch, spool 44 of which is shown in the figure.

In continuing reference to FIG. 2, housing 43, being supported by ceiling bracket 42 also contains second part 51 of mounting bracket 50. Cable 45 is payed out or withdrawn over spool 44 by actuation of a two-way motor (not shown). Cable 45 passes through an opening in housing 43 and through an opening in its lower surface through second part 51 of mounting bracket 50 and is affixed to first part 52 of mounting bracket 50 such as described in reference to FIG. 1. Also as in FIG. 1, fixture unit 22 is affixed to the bottom of first part 52 of mounting bracket 50 to complete the installation.

In comparing FIGS. 1 and 2, it is noted that in FIG. 1, winch 11 is placed above stud or rafter 14 as the winch is installed during construction. However, when an existing ceiling fixture is retrofitted with the present invention, ceiling bracket 42 is used not to engage fixture unit 22 but is instead used in mounting housing 43 containing the appropriate winch and portion of mounting bracket 50.

Although not shown, it should be readily apparent that, as a preferred embodiment, the winch in either installation can include stops for lowering the fixture to a preselected elevation and for stopping the winch where the halves of the mounting brackets meet. In doing so, electrical contact rings 17/19 and 53/54 engage in physical contact enabling the appropriate fixture to be electrified only when appropriately raised to its final at rest height. To cushion and insulate the joining of mounting bracket halves, an appropriate foam, rubber or plastic membrane 55 can be placed at the interface between mounting bracket halves. This not only cushions the joining of mounting bracket halves, but also acts as a further enhancement to prevent the unintended rotation of mounting bracket halves.

In turning to FIGS. 3a and 3b, it is noted that the present invention can be used in virtually any standard overhead fixture, the reference to ceiling fans and chandeliers being made for illustrative purposes. Again, turning to FIG. 3a, it is noted that fixture unit 22 could be lowered to enable a user to dust blades 32 which would otherwise be inaccessible without use of a ladder. In doing so, when lowered, motor 31 of ceiling fan 30 is deprived of electrical contact thus minimizing risk to a user.

Similarly, in reference to FIG. 3b, fixture unit 22 could be lowered to an appropriate height enabling a user to change depleted bulbs 34 and to dust and clean debris from hanging crystals 36 emanating from chandelier arms 33. Again, without use of the present invention, changing bulbs 34 and cleaning crystals 36 would be very difficult and potentially dangerous. It one was to lose one's balance on a ladder, the natural tendency would be to grab chandelier arm 33 which, in all likelihood, would break away from the chandelier or cause the entire fixture 35 to disengage from its supporting bracket. This could obviously result in severe injury and potentially loss of life in addition to structural damage resulting therefrom.

This invention can also be implemented by providing a remote control receiver and switch to actuate motors 13 and 31. A suitable antenna 1 can receive a signal from a hand held remote control unit (not shown) for controlling actuator 2 which in turn controls the motor (FIG. 1).

What is claimed is:

1. A device for facilitating the maintenance of an electrical fixture hung from a ceiling, said fixture being joined to a multi-part mounting bracket, a first part of said mounting bracket being affixed to said fixture and a second part of said mounting bracket being affixed to said ceiling, a cable affixed to said first part of said mounting bracket and to a winch for selectively paying out and withdrawing said cable for selectively lowering said first part of said mounting bracket and said fixture and for selectively separating said first and second parts of said mounting bracket.

2. The device of claim 1 wherein said first and second parts of said mounting bracket comprise electrical connectors aligned with one another such that when said first and second parts of said mounting bracket are in a first orientation, electric current is capable of passing therethrough for selectively powering said electrified fixture and when said first and second parts of said mounting bracket are in a second orientation electric current does not pass therethrough.

3. The device of claim 2 wherein said first and second parts of said mounting bracket are in contact with one another in said first orientation and are separated from one another in said second orientation.

4. The device of claim 1 wherein said winch comprises a spool and two-way motor, said spool rotatable in a first direction for paying out said cable and rotatable in a second direction for withdrawing said cable by winding said cable on said spool.

5. The device of claim 1 wherein said winch is mounted on said ceiling on an opposite side of said ceiling from said mounting bracket.

6. The device of claim 4 wherein said two-way motor is controllable by a switch.

7. The device of claim 4 wherein said two-way motor is controllable by a wireless remote control.

8. The device of claim 6 wherein said switch is located in a position accessible to a user of said device.

9. The device of claim 1 wherein said electrified fixture comprises a ceiling fan.

10. The device of claim 1 wherein said electrified fixture comprises a chandelier.

11. A device for facilitating the maintenance of an electrical fixture hung from a ceiling, said fixture being joined to a multipart mounting bracket, a first part of said mounting bracket being affixed to said fixture and a second part of said mounting bracket being affixed to said ceiling, a cable affixed to said first part of said mounting bracket and to a winch for selectively paying out and withdrawing said cable for selectively lowering said first part of said mounting bracket and said fixture and for selectively separating said first and second parts of said mounting bracket and wherein said first and second parts of said mounting bracket comprise electrical connectors aligned with one another such that when said first and second parts of said mounting bracket are in a first orientation, electric current is capable of passing therethrough for selectively powering said electrified fixture and when said first and second parts of said mounting bracket are in a second orientation electric current does not pass there through.

12. A method of servicing an electrified fixture hung form a ceiling, said fixture being joined to a multi-part mounting bracket, a first part of said mounting bracket being affixed to said fixture and a second part of said mounting bracket being affixed to said ceiling, providing a cable affixed to said first part of said mounting bracket and a winch for selectively paying out and withdrawing said cable, selectively lowering said first part of said mounting bracket and said fixture through actuation of said winch. whereupon said first and second parts of said mounting bracket are separated.

13. The method of claim 12 wherein electric connectivity is broken between a power source and electrified fixture upon separation of said first and second parts of said mounting bracket.

14. The method of claim 12 wherein said fixture is lowered to a level such that said fixture is accessible to a user located proximate thereto.

15. The method of claim 14 wherein said fixture comprises a ceiling fan and said fixture is lowered to enable a user to clean dust from blades of said fan.

16. The method of claim 14 wherein said fixture comprises a chandelier and said fixture is lowered to enable a user to clean dust from the chandelier and to replace bulbs thereon.

17. A kit for converting an electrified fixture hung from a ceiling to facilitate maintaining said fixture, said fixture being supported by a ceiling bracket through which electrical service passes a housing configured to mount to and be supported by said ceiling bracket, said housing containing a winch for selectively paying out and withdrawing a cable and a second part of a mounting bracket, a first part of a mounting bracket being sized to affix to said fixture whereby the pay out of cable upon activation of said winch causes the first and second parts of said mounting bracket to separate lowering said fixture and interrupting electrical service thereto.

18. The kit of claim 14 further comprising a switch for selectively activating a two way motor for selectively turning said winch.

19. The kit of claim 18 wherein said switch is controllable by wireless remote control.
